(19) United States
(12) Patent Application Publication
(10) Pub. No.: US 2019/0251937 A1
(43) Pub. Date: Aug. 15, 2019

(54) Fingerless Digital Musical Effects Controller Glove

(71) Applicant: Eric Skyler Mulhern, Vineyard Haven, MA (US)

(72) Inventor: Eric Skyler Mulhern, Vineyard Haven, MA (US)

(21) Appl. No.: 16/266,052

(22) Filed: Feb. 2, 2019

Related U.S. Application Data
(60) Provisional application No. 62/629,076, filed on Feb. 11, 2018.

(51) Int. Cl. G10H 1/00; G01L 1/20; G01P 15/00; G06F 3/01

(52) U.S. Cl. CPC G10H 1/0066; G01L 1/20; G10H 2220/401; G06F 3/014; G01P 15/00

(57) ABSTRACT

The Fingerless Digital Musical Effects Controller Glove is a glove-mounted wearable device that includes a flex sensor placed to record the movement of a wearer's wrist, an accelerometer, and a flexible pressure sensor or switch on the palm of the glove. The device transmits data wirelessly to digital audio software running on an external personal computer, laptop, or smartphone, allowing users to control various parameters of the resultant sound or performance. The Fingerless Digital Musical Effects Controller Glove is so configured as to be perceived by the external computer as a MIDI or audio device, making it compatible with existing digital audio software. The glove is lightweight, flexible, and fingerless, allowing for unencumbered movement of the user's fingers—thus freely allowing simultaneous use of a musical instrument or other musical equipment.

### CROSS REFERENCE TO RELATED APPLICATIONS

I hereby claim benefit under Title 35, United States Code, Section 119(e) of U.S. provisional patent application Ser. No. 62/629,076 filed Feb. 11, 2018. The 62/629,076 application is currently pending. The 62/629,076 application is hereby incorporated by reference into this application.

### STATEMENT REGARDING FEDERALLY SPONSORED RESEARCH OR DEVELOPMENT

Not applicable to this application.

### BACKGROUND OF THE INVENTION

### 1. Field of the Invention

This invention relates to electronic musical instruments, more particularly to the wearable electronics device known as a data glove, as used in music production and artistic performances. Data gloves are wearable devices that use one or more sensors to track the movement of a user's hand. This data can be used to control various parameters within the device or can be sent to an external device such as a personal computer.

### 2. Description of the Related Art

Any discussion of the prior art throughout the specification should in no way be considered as an admission that such prior art is widely known or forms part of common general knowledge in the field.

Existing data gloves are used for a variety of purposes—mapping the user's hand motion in 3d space, controlling videogames, operating medical equipment, etc. Some are used for creating music. However, the designs of these are optimized for using the device itself as a solitary musical instrument, instead of being optimized for concurrent use of another musical instrument. As such, they limit the natural movement of the user's hand in ways that encumber the use of a musical instrument or other music hardware.

Furthermore, devices with sensors placed on the fingers may produce unintentional triggerings of those sensors while the user is playing another instrument. Such a device will also output too many parameters for the average user to conceptualize, especially while operating other musical equipment. With too many parameters for the user to keep track of, these devices provide a daunting and often inhibitory learning curve for anyone wishing to incorporate these devices into their performances. This problem is compounded by the necessity for the user to move their fingers independently in order to operate other aspects of their performance, such as musical instruments, other electronic devices, or even dancing.

U.S. Pat. No. 7,862,522B1 describes a data glove that is inhibitively bulky and cumbersome, preventing the concurrent use of other musical equipment or instruments.

U.S. Pat. Nos. 9,710,060B2, 9,189,022B2, 9,301,563B2, 9,529,433B2, EP3098691A1, U.S. Pat. No. 9,060,385B1, and WO2012054443A1 each detail a data glove having pressure and/or flex sensors located on a contact surface of one or more fingers of the glove, or on the knuckle joint of one or more fingers such that some portion of the sensor must extend across at least the lowest segment of the user's finger. This placement interferes with the free movement of the user's fingers, inhibiting the concurrent use of other musical equipment or instruments. Furthermore, these inventions are not generally optimized for musical production and artistic performances.

While many of these devices claim not to encumber the user's dexterity, it is inherent to their design that they do in fact inhibit the fine motor control of the user's fingers, and in so doing inhibit all but the most basic use of an instrument. Though some may be an improvement on earlier designs, they still limit the motion of the user's fingers to some degree. In technical performances, it is essential that the performer's dexterity be fully uninhibited to the greatest extent possible.

The Mi.Mu glove developed by Imogen Heap features flex sensors in the fingers of the glove, which similarly reduce the player's dexterity. U.S. Pat. No. 8,620,661B2 describes a data glove optimized specifically for a vocalist in the context of a musical or artistic performance, containing switches located at points on the thumb and fingers. This invention also does not employ flex sensors nor an accelerometer for the triggering of effects.

Other data gloves exist that are not optimized for music production. For example, Patents No. US20120025945 and WO2015175838A1 each describe devices that are not optimized for compatibility with digital audio software, thus inhibiting the average user from interfacing the device with existing music hardware.

### BRIEF OVERVIEW OF THE INVENTION

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the invention is to provide a data glove optimized for musical production and artistic performances.

Another object is to provide a device that will provide all the primary benefits of existing data gloves without the increased restriction to mobility that typically accompanies these devices.

A further object is to provide a device that does not result in unwanted triggerings of the data glove's functions during a musical or artistic performance.

A further object is to provide a device that provides an optimal number of parameters for the user to control; neither too few to hamper the user's creativity, nor too many for the user to readily conceive of being able to control simultaneously.

A further object is to provide a device that will provide all the above objects while remaining approachable and aesthetically attractive to the intended user.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of one instance of the present invention.

FIG. 2 is an upper perspective of an alternate configuration of the invention.

FIG. 3 is an upper perspective of an alternate configuration of the invention.

FIG. 4 is a lower perspective view of one instance of the present invention.

FIG. 5 is a perspective view of the electronics housing unit.

FIG. 6 is an exploded perspective view of the electronics housing unit.

FIG. 7 is a top-down view of the electronics housing unit.

FIG. 8 is a schematic of a circuit board implementing the present invention, where FIGS. 8A, 8B, 8C, and 8D collectively comprise one complete circuit. Names of individual components correspond to the manufacturer's part number for the particular components used in this circuit.

FIG. 9 is a top-down view of one instance of a circuit board layout of the present invention, showing several of the reference characters connected via traces, and including placement of resistors, capacitors, and other supporting components that do not warrant a reference character, as their existence is implied by the presence of those components that are marked with a reference character.

FIG. 10 is a bottom-up view of one instance of a circuit board layout of the present invention, showing several of the reference characters connected via traces, and including placement of resistors and other supporting components that do not warrant a reference character, as their existence is implied by the presence of those components that are marked with a reference character.

FIG. 11 is a flowchart of the flow of data in the present invention.

FIG. 12 is a block diagram of the present invention.

### DETAILED DESCRIPTION OF THE INVENTION

### A. Overview

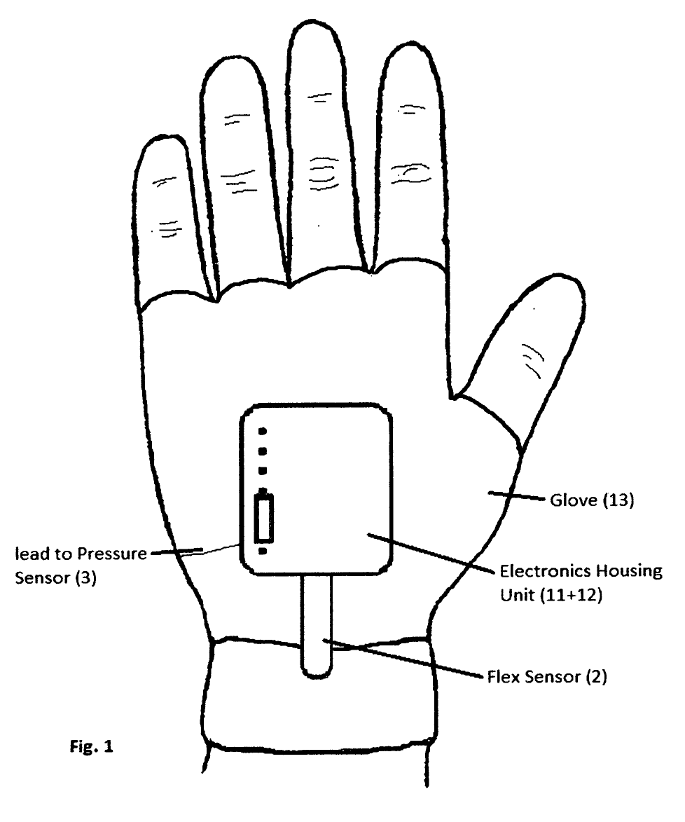

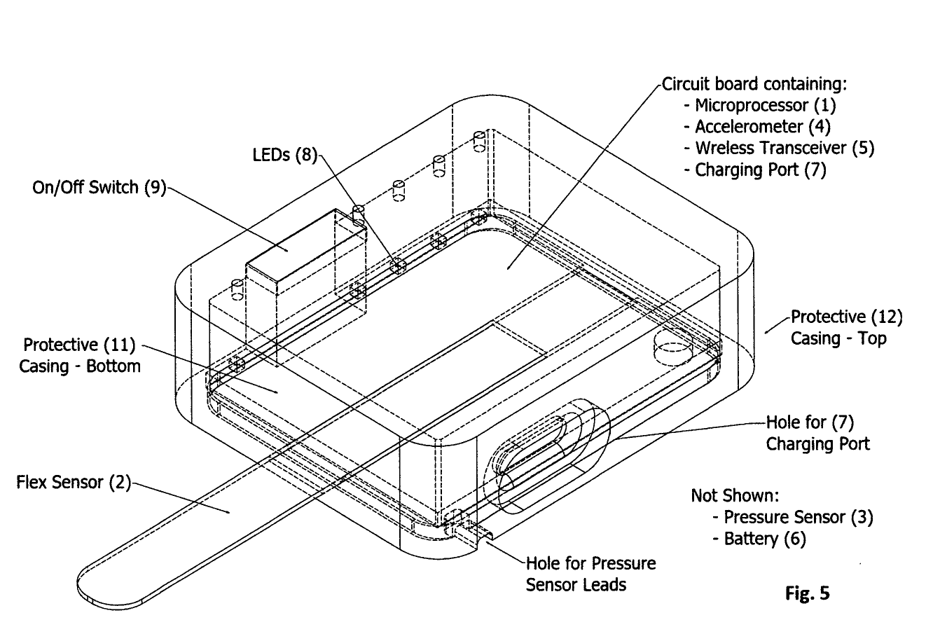

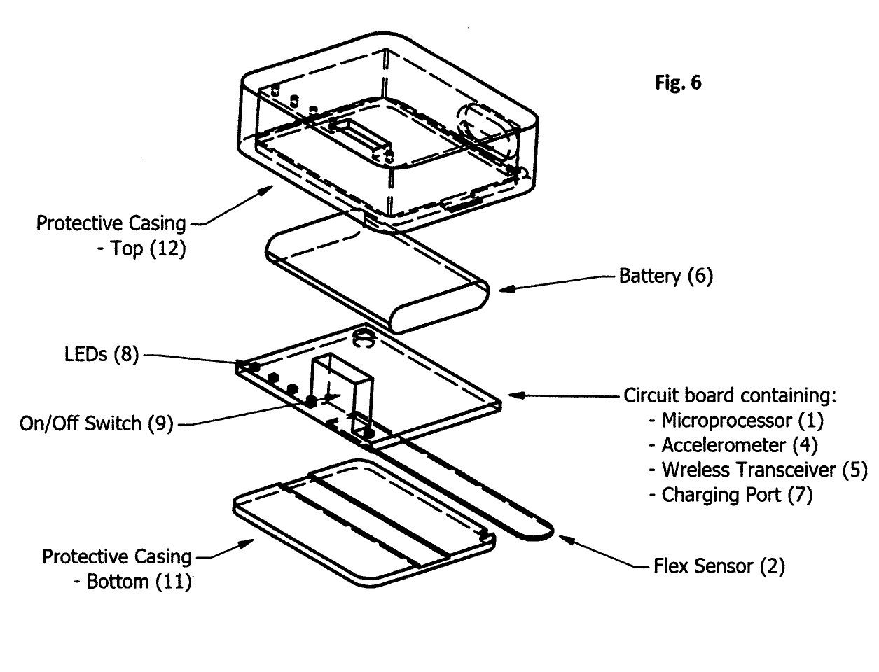

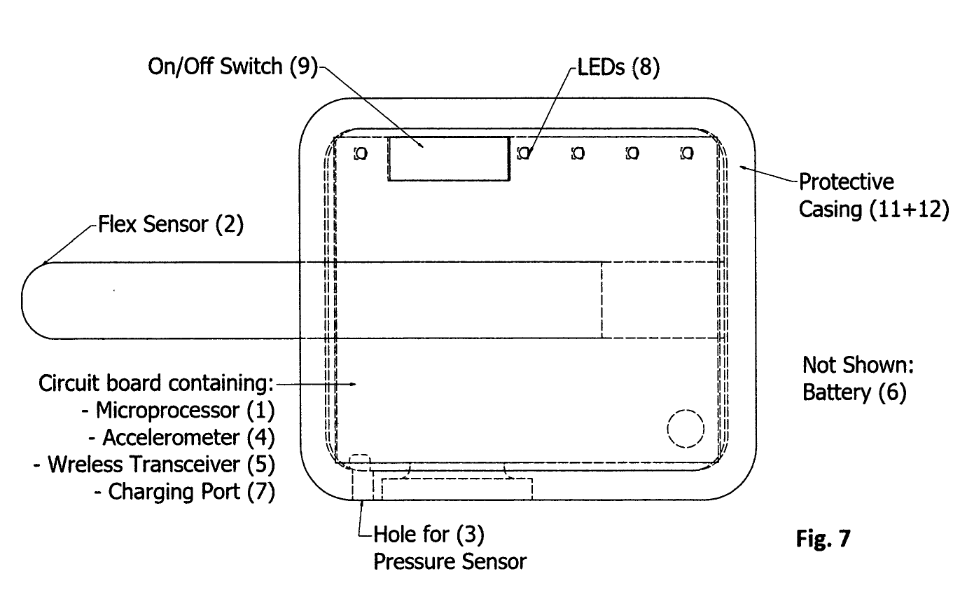

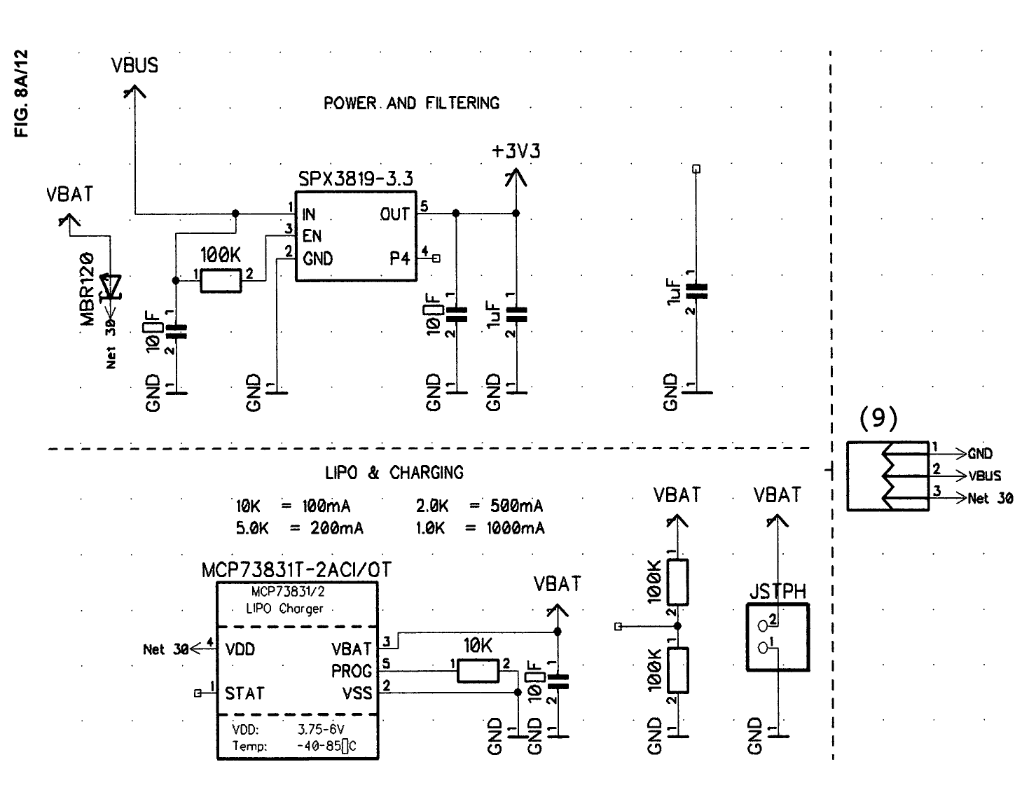

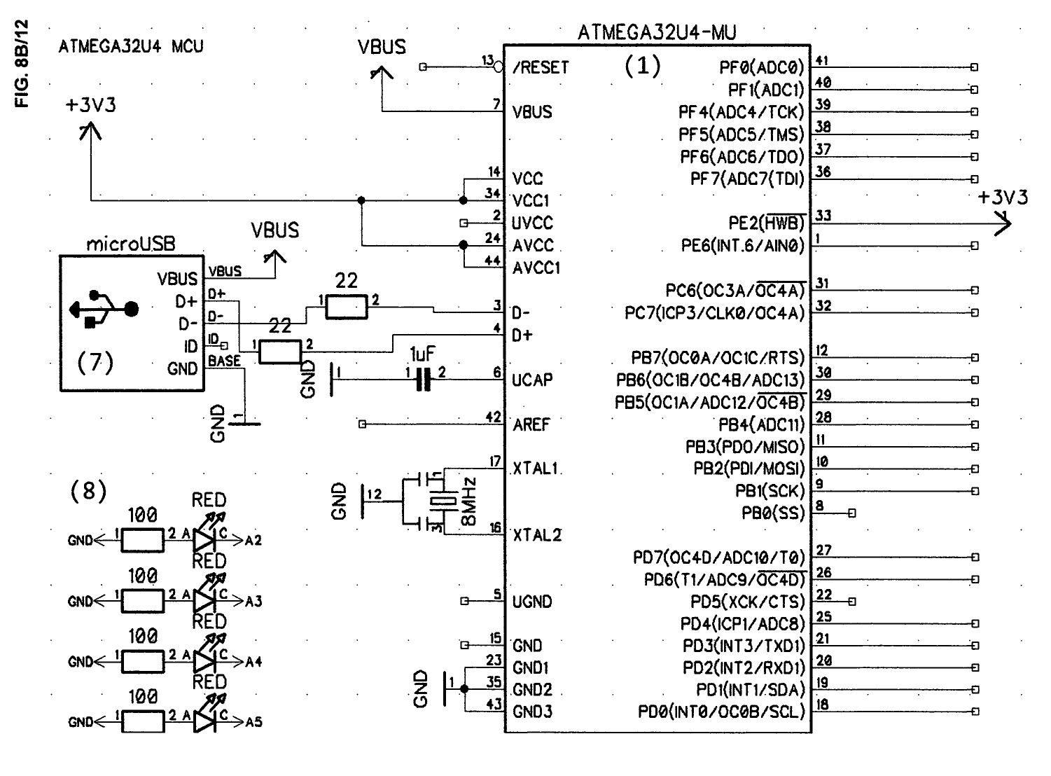

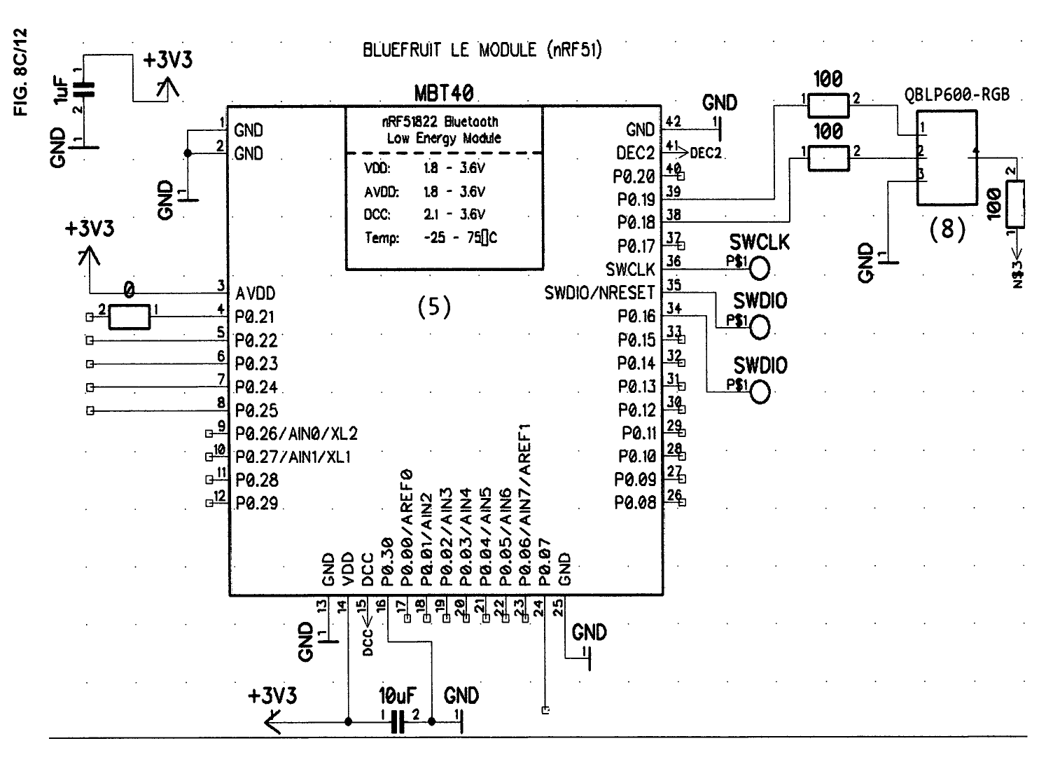

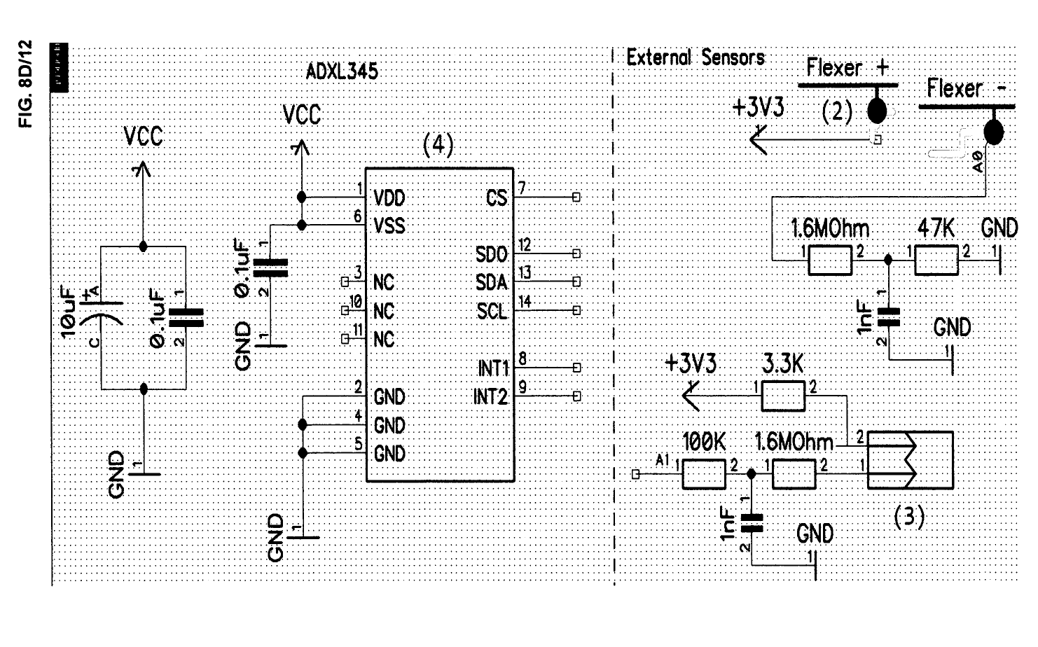

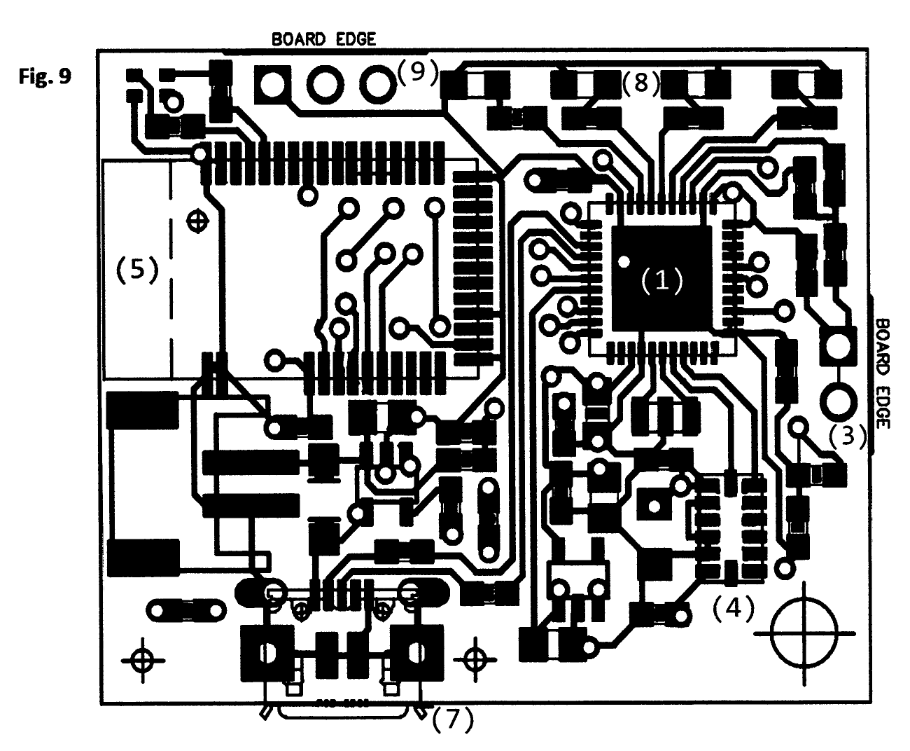

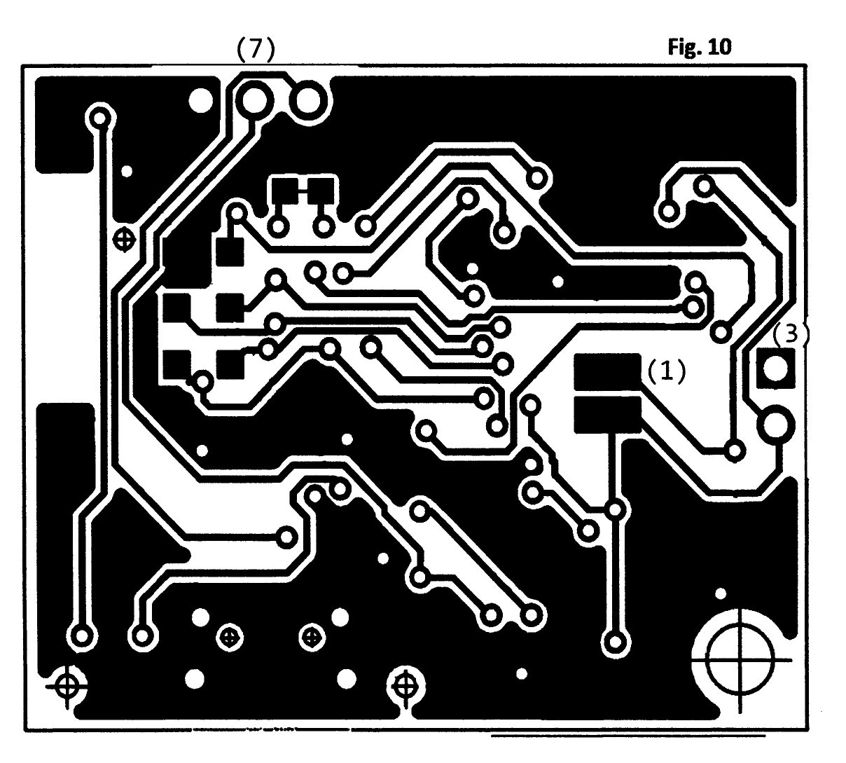

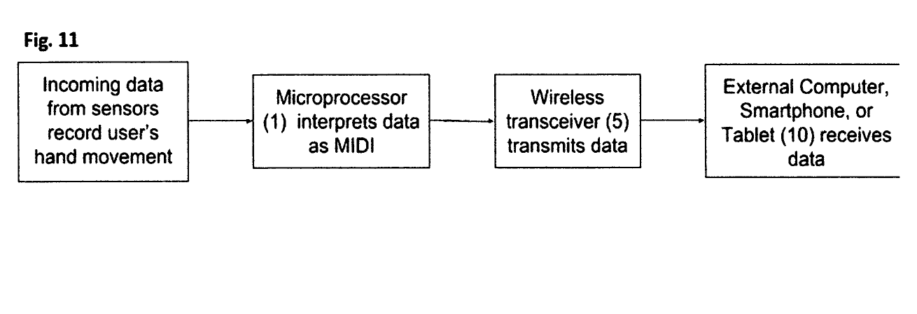

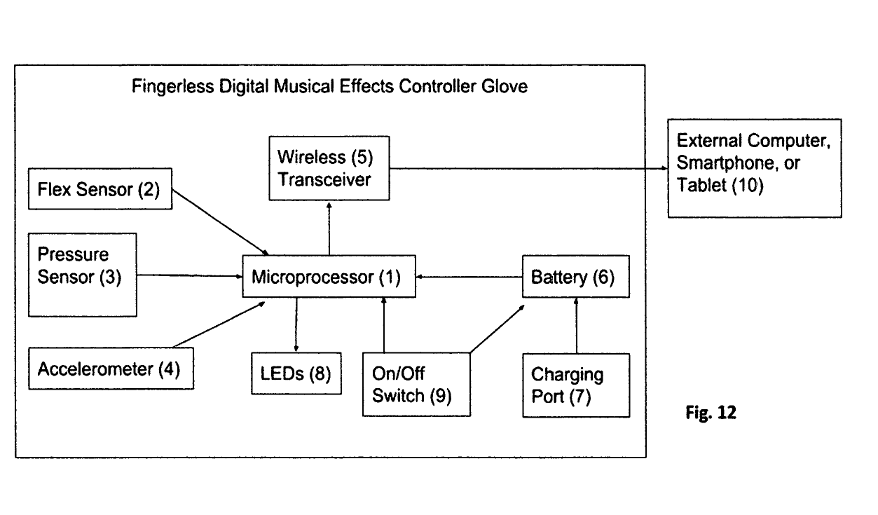

Turning now descriptively to the drawings, in which similar reference characters denote similar elements throughout the several views, FIGS. 1 through 4 illustrate several instances of the present invention consisting of a glove attached to an Electronics Housing Unit (11+12), from which extend a Flex Sensor (2) and a Pressure Sensor (3). FIGS. 5 through 7 illustrate the electronics housing unit of the present invention, consisting of a Protective Casing (11+12) and its contents. Contained within the Protective Casing (11+12) is a circuit board on which are mounted components (1) through (9), shown in FIGS. 8-10. FIGS. 11 and 12 show the structure of the internal circuitry and the flow of data through the present invention.

### B. Microprocessor (1)

A Microprocessor (1) that receives data from the sensors (2), (3), and (4), and processes the data in such a way that it can be interpreted by existing digital music software on an external computer, smartphone, or tablet (10). Preferably, the data is structured in the MIDI format and concurrently in the serial format. The Microprocessor (1) relays this data to a Wireless Transceiver (5). The Microprocessor (1) also causes the Light Emitting Diodes (or LEDs) (8) to give visual representation to the user as to the state of the unit.

### C. Flex Sensor (2)

A variable resistor protruding from the case (11+12) so as to extend across the wrist of the glove. In its preferred embodiment, this flex sensor is 2.2 inches long and protrudes 1.5 inches from the outside of the casing. This configuration provides the user with a fine degree of accuracy when controlling a parameter of data, recording the degree to which the user's wrist is bent backwards.

### D. Pressure Sensor (3)

A variable resistor preferably made from a 1″×1″ piece of conductive fabric mounted above the hypothenar eminence area of the palm on either the inside or the outside of the glove, and connected by leads to the circuit board. This configuration is optimally placed so as to allow users to trigger this sensor with a simple gesture such as clapping or pressing their palm against a table or the neck of a guitar. The flexible nature of the sensor allows for a glove that is more comfortable for the user to wear.

### E. Accelerometer (4)

An Accelerometer (4) that relays information as to the acceleration and rotational position of the device to the Microprocessor (1). In some instances, the Accelerometer (4) may be configured to trigger various effects through detection of certain movements of the hand.

### F. Wireless Transceiver (5)

A Wireless Transceiver (5) that transmits data received from the Microprocessor (1) to be received by an external computer, smartphone, or tablet (10). In its preferred embodiment, the Wireless Transceiver (5) is a Bluetooth Low Energy device.

### G. Battery (6)

In the preferred embodiment, this battery is a 400 mAh rechargeable Lithium Ion battery, connected by leads to the circuit board.

### H. Charging Port (7)

A Charging Port (7), preferably in the form of a USB Micro A female port.

### I. LEDs (8)

A plurality of LEDs (8), from which the light is preferably conducted by 1 mm diameter acrylic rod to the outer surface of the Protective Casing Top (12). The LEDs are preferably programmed so as to provide visual feedback corresponding to the state of the device, including data as to the positions and, states of the sensors (2), (3), and, (4), the current charge of the Battery (8), and the connectivity statuses of the Charging Port (7) and the Wireless Transceiver (5). In one instance of the invention, there are 4 red LEDs spaced evenly across the top of the device and one RGB LED, each 1 mm×1 mm.

### J. On/Off Switch (9)

An On/Off Switch (9), preferably 4.5 mm long by 2 mm wide, protruding from the circuit board and extending so that its upper surface is flush with the outer surface of the Protective. Casing. Top (12).

### K. Protective Casing (11+12)

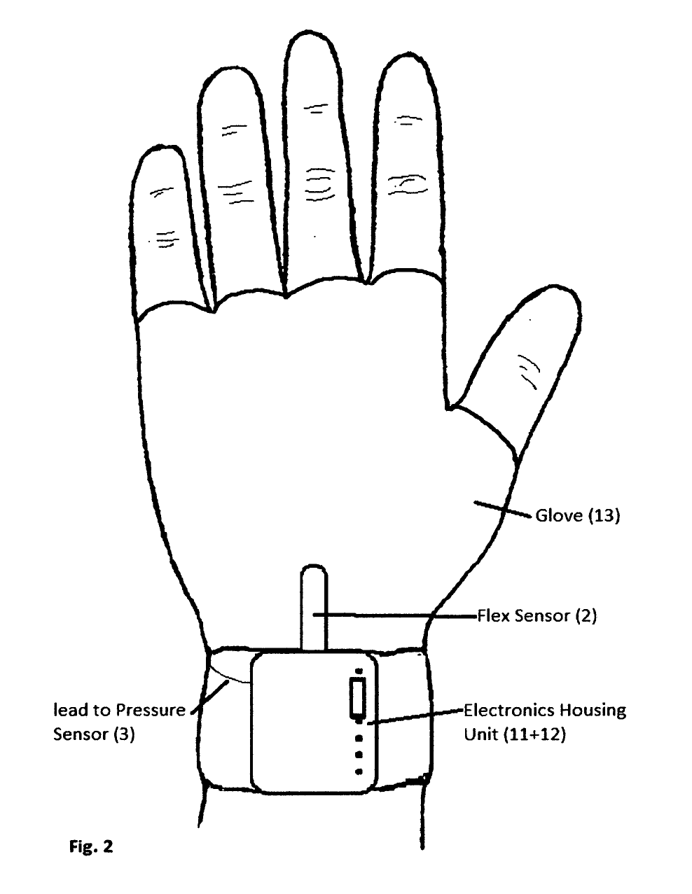

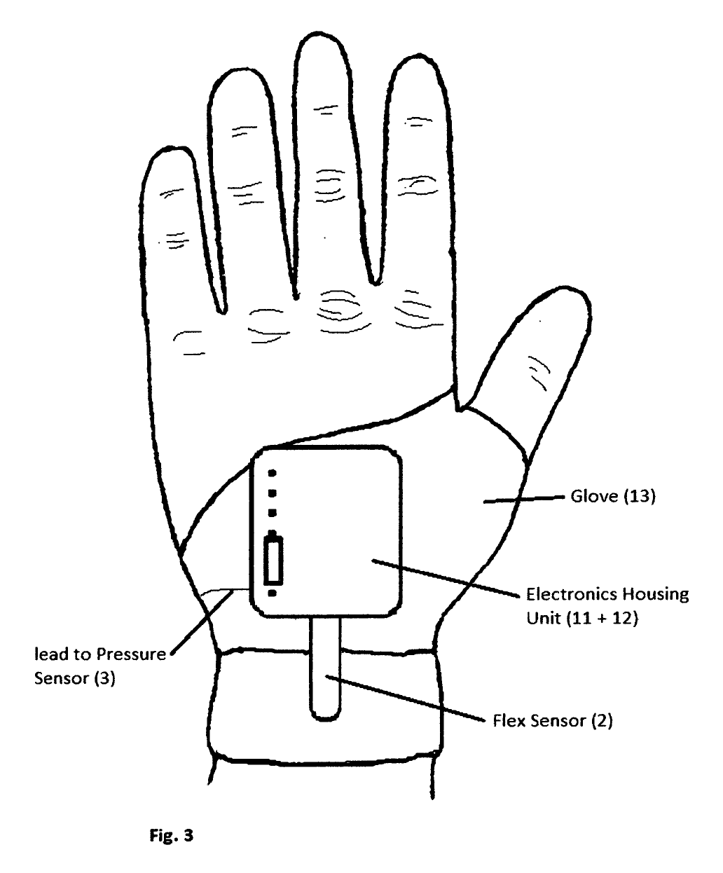

A Protective Casing (11+12), which is in the preferred embodiment comprised of a Protective Casing Top (12) and a Protective Casing Base Plate (11). In the preferred embodiment this casing is made of a rigid plastic material so as to protect its contents from physical trauma, and is sealed so as to provide water resistance. The Protective Casing Top (11) contains holes to provide access to the On/Off Switch (9) and the LEDs (8), as well as holes for the Flex Sensor (2), Pressure Sensor (3), and Charging Port (7). Housed within this casing are components (1)-(2) and (4)-(9). In one instance of the present invention, the Protective Casing (11+12) is 44 mm by 37 mm by 12 mm in size. The electronics housing unit (11+12) is preferably positioned on the Glove (13) so as to minimize any reduction in mobility of the user. In one instance of the present invention, the electronics housing unit (11+12) is positioned in the lower center of the back of the hand, as seen in FIGS. 1 and 3. In another instance of the present invention, the electronics housing unit (11+12) is positioned on the forearm of the user just above the wrist, as seen in FIG. 2.

### L. Glove (13)

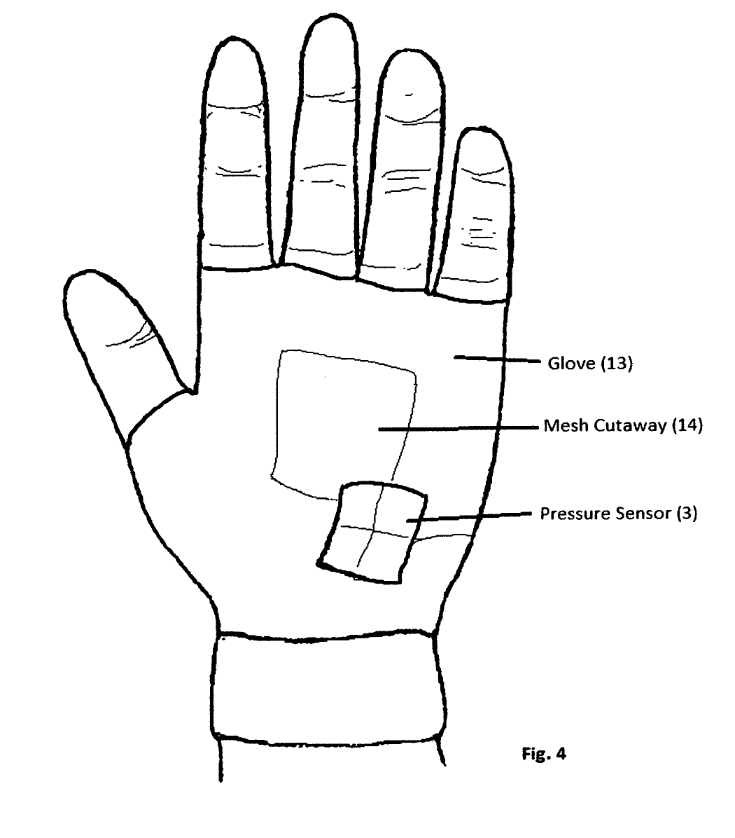

A glove (13) preferably made of a thin, lightweight and stretchy material with a mesh cutaway (14) area across the palm to reduce sweating. In the preferred embodiment, the glove is minimally designed so as to provide the most freedom of movement to the wearer as is possible. In one instance of the present invention, as seen in FIGS. 1 through 3, the glove is shaped as a standard fingerless glove, with the fingers of the glove extending an absolutely minimal distance along the length of the user's fingers. In another instance of the present invention, as seen in FIG. 4, the glove is cut away so as to leave a majority of the user's hand and palm bare.

I claim:

1. A data glove optimized for musical production and artistic performance, comprising:
a glove of flexible material;
a device mounted to a flexible glove comprised of
a flex sensor positioned to record the movements of a user's wrist, as well as
a flexible pressure sensor or switch placed on the palm of the glove,
an accelerometer,
a wireless communication port to transmit values from the above sensors to an external device,
an onboard microprocessor to store basic functions and route values from the sensors to the wireless communication port,
a rechargeable battery,
an electrical port for charging the battery,
a plurality of LEDs to provide visual feedback of the status of the device,
an on/off switch, and
a protective casing surrounding the internal circuitry.

2. The data glove of claim 1, wherein the glove is made of a lightweight, stretchable material.

3. The data glove of claim 2, wherein the electronic components are positioned so as not to be positioned on any part of the user's fingers.

4. The data glove of claim 3, wherein the palmar area of the glove is ventilated so as to reduce sweating.

5. The data glove of claim 4, wherein the protective casing is sealed so as to provide water-damage resistance.

6. The device of claim 1, wherein the flex sensor used is 2.2 inches in length.

7. The device of claim 1, wherein the pressure sensor is comprised of two perpendicular threads of conductive material passing through a sheet of conductive fabric.

8. A configuration of the device of claim 1, wherein the device is perceived by external devices as a MIDI controller; mapping each of the parameters of the sensors to various MIDI channels.

9. A configuration of the device of claim 1, wherein the device is turned on and off based on inactivity and movement recorded by the accelerometer and/or flex sensor.

10. The data glove of claim 1, wherein the electronics housing is mounted to the glove over the back of the hand.

11. The data glove of claim 1, wherein the electronics housing is mounted to the glove above the wrist on the forearm of the user.

12. The data glove of claim 1, wherein the battery is mounted to the glove above the wrist on the forearm of the user and the electronics housing is mounted to the glove over the back of the hand.

13. The device of claim 4, wherein the flex sensor is placed on inside the of the glove.

14. The device of claim 4, wherein the flex sensor is placed in a sleeve on the outside of the glove.

15. The device of claim 5, wherein the protective casing is made of a plastic material.

16. The device of claim 5, wherein the protective casing is made of aluminum.

17. The device of claim 5, wherein the protective casing is made of carbon fiber.

18. The device of claim 5, wherein the protective casing is made of a fabric material.

19. The device of claim 1, wherein the casing is attached to the glove via a common method of affixation such as velcro, thread, tape, or glue.
